(19) United States
(12) Patent Application Publication
(10) Pub. No.: US 2013/0158811 A1
(43) Pub. Date: Jun. 20, 2013

(54) DRIVING ASSISTANCE DEVICE AND CAR USING THE SAME

(71) Applicant: CHIEN-CHUN FU, Tu-Cheng (TW)

(72) Inventor: CHIEN-CHUN FU, Tu-Cheng (TW)

(73) Assignee: HON HAI PRECISION INDUSTRY CO., LTD., Tu-Cheng (TW)

(21) Appl. No.: 13/598,632

(22) Filed: Aug. 30, 2012

(30) Foreign Application Priority Data
Dec. 19, 2011 (TW) 100147001

(51) Int. Cl. B60Q 1/076; G01C 21/34

(52) U.S. Cl. 701/49

(57) ABSTRACT

A car includes a driving assistance device and two auxiliary lights, capable of being rotated, arranged at a front side of the car. The processor of the driving assistance device obtains real-time geographical position of the car according to data from the geographical information obtaining module of the driving assistance device, and when the car reaches one of the one or more left turn points or right turn points, the processor turns on the light and controls the rotary auxiliary lights to point to the left or to point to the right.

### BACKGROUND

1. Technical Field

The present disclosure relates to a car with a driving assistance device, and particularly, to a car including a driving assistance device and auxiliary lights controlled by the driving assistance device.

2. Description of Related Art

Vehicles including global positioning system (GPS) guidance devices are well known. Although guidance devices of related art can satisfy basic requirements, a new car with driving assistance device is required.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is block diagram of a car with a driving assistance device in accordance with an embodiment.

FIG. 2 is a schematic view of the car of FIG. 1 going around a bend to the right making a left turn.

### DETAILED DESCRIPTION

Embodiments of the present disclosure will be described with reference to the accompanying drawings.

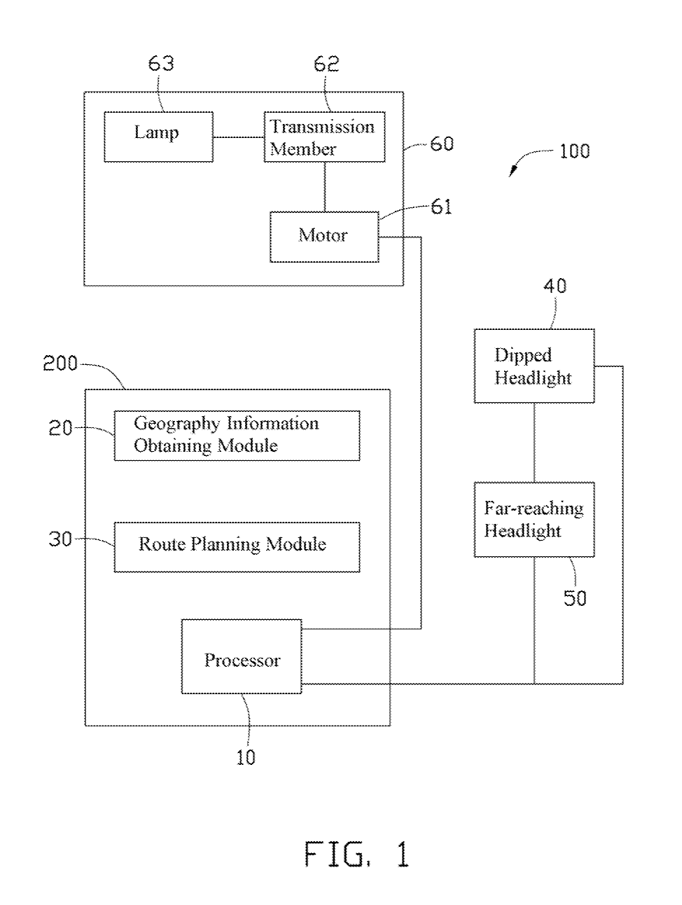

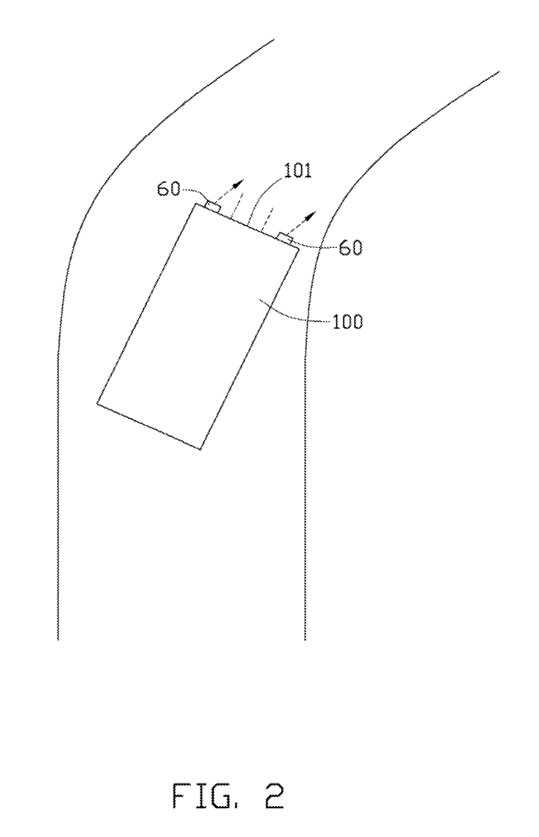

Referring to FIGS. 1 and 2, a car 100 includes a driving assistance device 200. The driving assistance device 200 includes a processor 10, a geographical information obtaining module 20, and a route planning module 30.

The geographical information obtaining module 20 obtains geographical information of the car 100 from satellites. For example, the geographical information obtaining module 20 can obtain data from GPS satellites and determine the geographical position of the car 100.

The route planning module 30 generates one or more routes in response to a user input. For example, a user can input a starting location and a destination location, and the route planning module 30 can determine one or more routes from the starting location to the destination location based on a map database. The route planning module 30 can also determine left turns/right turns required at intersections of the route selected from the one ore more routes, and send data as to the determined left turns/right turns to the processor 10.

The car 100 further includes two dipped headlights 40, two far-reaching headlights 50 and two auxiliary lights 60 arranged adjacent to the dipped headlights 40 at a front side 101 thereof. In the embodiment, each auxiliary light 60 includes a motor 61, a transmission member 62 and a lamp 63 coupled to the transmission member 62. The transmission member 62 is connected to the motor 62 and can move the lamp 63 to the right or to the left when the motor 61 rotates in a forward/reverse direction.

A user can start the driving assistance device 200 at night, and select a route from a number of routes planned by the driving assistance device 200. The processor 10 monitors the real-time geographical position of the car 100 according to data from the geographical information obtaining module 20. When the car 100 reaches a left/right turn point, the processor 10 turns on the auxiliary lights 60 and signals the motor 61 to make a forward/reverse rotation, such that the transmission member 62 causes the light beams from the lamp 63 to illuminate the areas that the dipped headlights 40 and the far-reaching headlights 50 cannot reach. For example, when the car 100 reaches a left turn point, the lamp 63 will be rotated to the left by the transmission member 62; when the car 100 reaches a right turn point, the lamp 63 will be rotated to the right by the transmission member 62. After the car 100 has passed the left/right turn point, the processor 10 turns off the auxiliary lights 60 and signals the motor 61 to rotate to the median position, such that the transmission member 62 will return to its original position.

In the embodiment, the geographical information of the car 100 obtained from satellites further includes altitude information. The processor 10 monitors the altitude of the car 100 according to the altitude information. When the car 100 moves upslope/downslope, the altitude of the car 100 changes. When the change of the altitude of the car 100 exceeds a preset value, the processor 10 turns on the dipped headlights 40 or the far-reaching headlights 50 for a preset time period. For example, when the altitude of the car 100 increases gradually, which means the car 100 is moving upslope, the processor 10 turns on the far-reaching headlights 50; when the altitude of the car 100 decreases gradually, which means the car 100 is moving downslope, the processor 10 turns on the dipped headlights 40.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A car comprising:
a driving assistance device comprising:
a processor;
a geographical information obtaining module to obtain geographical information of the car, and to determine a geographical position of the car; and
a route planning module to plan one or more routes in response to a user input, and to determine one or more left turn points or right turn points of one route selected from the one or more routes by a user; and
two rotary auxiliary lights arranged at a front side of the car, wherein the processor obtains real-time geographical position of the car according to data from the geographical information obtaining module, and when the car travels to one of the one or more left turn points or right turn points, the processor turns on the light and controls the rotary auxiliary lights to turn left or turn right.

2. The car according to claim 1, wherein each auxiliary light comprises a motor, a transmission member connected to the motor and a light connected to the transmission member, the light is rotatable with the transmission member when the motor rotates.

3. The car according to claim 1, wherein the geographical information obtaining module obtain geographical information of the car from global positioning system (GPS) satellites.

4. The car according to claim 1, wherein after the car has passed the one of the one or more left turn points or right turn points, the processor turns off the lights and controls the rotary auxiliary lights to rotate to an original position thereof.

5. A driving assistance device for use with a car that comprises two rotary auxiliary lights arranged at a front side of the car, the driving assistance device comprising:
a processor;
a geographical information obtaining module to obtain geographical information of the car, and to determine a geographical position of the car; and
a route planning module to plan one or more routes in response to a user input, and to determine one or more left turn points or right turn points of one route selected from the one or more routes by a user;
wherein the processor obtains real-time geography position of the car according to data from the geographical information obtaining module, and when the car travels to one of the one or more left turn points or right turn points, the processor turns on the light and controls the rotary auxiliary lights to turn left or turn right.

6. The driving assistance device according to claim 5, wherein each auxiliary light comprises a motor, a transmission member connected to the motor and a light connected to the transmission member, the light is rotatable with the transmission member when the motor rotates.

7. The driving assistance device according to claim 5, wherein the geographical information obtaining module obtain geographical information of the car from global positioning system (GPS) satellites.

8. The driving assistance device according to claim 5, wherein after the car has passed the one of the one or more left turn points or right turn points, the processor turns off the lights and controls the rotary auxiliary lights to rotate to an original position thereof.
